(19) United States
(12) Patent Application Publication
(10) Pub. No.: US 2013/0053257 A1
(43) Pub. Date: Feb. 28, 2013

(54) RANTES Multiplexed Assay, RANTES Variants Related to Disease, and RANTES Variants Related to Enzymatice Activity

(71) Applicants: Paul E. Oran, Phoenix, AZ (US); Randall W. Nelson, Phoenix, AZ (US)

(72) Inventors: Paul E. Oran, Phoenix, AZ (US); Randall W. Nelson, Phoenix, AZ (US)

(21) Appl. No.: 13/577,638

(22) PCT Filed: Feb. 7, 2011
(86) PCT No.: PCT/US11/23910

§ 371 Date: Nov. 2, 2012

Related U.S. Application Data
(60) Provisional application No. 61/302,406, filed on Feb. 8, 2010.

(51) Int. Cl. C40B 20/08

(52) U.S. Cl. 506/6

(57) ABSTRACT

The present invention relates to multiplexed assays for the diagnosis of RANTES-based disorders. Essentially, a single, high information content RANTES assay is used to simultaneously determine an individual's disposition towards a disease as well as the onset and progression of the disease (or response to treatment). As such, the (single) analysis has the particular advantage of always producing data useful in the longitudinal monitoring (of individuals) for a disease. In specific example, the discovery relates RANTES isoforms with the predisposition, onset and progression of T2D, CHF, MI, and cancer. All isoforms of particular blood and urine borne proteins—containing protein phenotype data—are monitored in a single, high throughput analysis able to acquire data relevant to the stages of the disease (or treatment).

### RELATED APPLICATIONS

The present application is filed claiming the benefit of priority to U.S. Provisional Patent Application No. 61/302,406, which was filed on Feb. 8, 2010. The entire text of the aforementioned application is incorporated herein by reference in its entirety.

### BACKGROUND OF THE INVENTION

RANTES is member of the chemokine family of cytokines. It is a β-chemokine that has a sixty-eight amino acid sequence (SEQ ID NO:1). Chemokines have the ability to recruit and activate a wide variety of proinflammatory cell types. RANTES is a chemoattractant cytokine that plays a role in inflammatory responses and has been shown to elicit an inflammatory response in vivo. RANTES, along with the natural ligands for the CCR5 chemokine receptor, MIP-1α, MIP-1β, were found to inhibit human immune deficiency virus type-1 (“HIV-1”) infection, which finding ultimately led to the identification of CCR5 as the major co-receptor for primary isolates of HIV-1, HIV-2 and SIV-1. However, although RANTES consistently inhibits HIV-1 replication in peripheral blood mononuclear cells, it does not block infection of primary macrophage cultures, which suggests that RANTES would not influence HIV replication in non-lymphocyte cell types.

Others have shown that N-terminal modifications such as N-terminal truncation, addition of addition of methionine (“Met-RANTES”) or aminooxypentane (“AOP-RANTES”) at the N-terminus of RANTES produce RANTES antagonists that can block HIV-1 infection without signaling calcium flux. Further, N-terminally modified RANTES, with a higher affinity for CCR5 than native RANTES are more potent than native RANTES in blocking infection.

Similar to other CC chemokines, RANTES is a monocyte chemoattractant. RANTES can also chemoattract unstimUlated CD4+/CD45RO+ memory T cells and stimulated CD4+ and CD8+ T cells with the naive and memory phenotypes. In addition, RANTES can chemoattract and degranulate eosinophils, as well as chemoattract and induce histamine release from basophils. Recently, human RANTES has been shown to be an inhibitor of HIV infection of human mononuclear cells. Several CC chemokine receptors, including CCR-1, CCR-3, CCR-4 and CCR-5, have been shown to bind RANTES and subsequently to transduce a signal by increasing the intracellular calcium ion level.

Thus, the clinical significance of RANTES is considerable as it has been associated with many diseases including kidney related complications (e.g. renal failure and renal cancer), autoimmune diseases (e.g. arthritis, diabetes, and glomerulonephritis), and several forms of carcinoma including breast and cervical cancer. Indeed, plasma RANTES levels have been found increase in order of cancer stage (I, II, III, or IV). Furthermore, a large population study found RANTES in higher plasma concentrations in subjects with Type 2 diabetes and impaired glucose tolerance (IGT) relative to healthy controls. Concerning viral relevance, RANTES was discovered to be an effective antiviral agent that restricts the entry of CCR5-tropic HIV-1 strains by means of the CCR5 receptor. The 3-68 variant form of RANTES was subsequently found to also inhibit HIV to the same degree but lacked the same binding affinity to the CCR1 receptor.

In an age where there is increasing focus on personalized medicine there is a need for specific tools that can be used to rapidly predict, diagnose and monitor disease progression and treatment. The impact of RANTES microheterogeneity in biological systems cannot be underestimated. Regrettably, it is still somewhat unknown as to whether RANTES and its related variants, on the contrary from a “singular” concentration value, may hold clinical significance in the analyses of different disease states. The present invention is directed to providing a multiplexed RANTES assay able to simultaneously detect, identify, and quantify endogenous RANTES variants with the intention to simultaneously diagnose and monitor the progression (or effective treatment) of a disease.

Ideally, a single assay for any disease will be able to simultaneously predict, diagnose and monitor the progression (or effective treatment) of the disease. This invention accomplishes these goals using a single assay to measure an individual's specific protein phenotype and the relative abundance of the protein phenotype(s) as they relate to a disease. Notably, any one gene can produce multiple, qualitatively different proteins in varying amounts when posttranslational modifications are considered. Thus, an individual's protein phenotype (for any one gene—gene product combination) contains additional qualitative, quantitative and temporal components. Simply put, the protein phenotype builds upon the initial description of an in vivo protein by considering, e.g., quantitative modulations in the posttranslational variants. This considered, an ideal single—measurement assay would be able to simultaneously monitor several molecular variants of products from a given gene, revealing an individuals protein phenotype relative to disease.

### BRIEF SUMMARY OF THE INVENTION

The present invention for the first time shows that there are several RANTES protein variant forms related to disease and thus, describes the use of a multiplexed RANTES assay that can simultaneously detect, determine, identify, and quantify these new RANTES variant forms (along with previously established variants forms). Individual ratios of each variant can then be used detect the presence of disease, severity of disease, and effect of therapy.

### BRIEF DESCRIPTION OF SEVERAL VIEWS OF THE DRAWINGS

FIG. 1. Mass spectrum resulting from the targeted top-down analysis of RANTES (from Panel B). Indicated are signals from the ˜23 major protein isoforms. Isoforms fall into six categories: c- and n-terminal truncation, n-terminal truncation only, c-terminal truncation only, multiple truncation possibilities (due to identical masses), glycosylation, and glycation. RANTES signals corresponding to oxidation (+16 Da) were not labeled. Table 1 lists the identities of each variant.

FIG. 2. Mass spectra from a T2D individual and a non-T2D individual. Table 1 lists the identities of the individual variants. Note the correlation between the ratio of [1-68] and [3-68] to the ratio of the glycosylated equivalents. Also note the increase in glycation observed in the T2D sample.

FIG. 3. Population data for mixed cohort of ˜250 individuals. Isoforms representing 90% of RANTES. Healthy individuals subtyped into plasma samples (n=37) and serum samples (n=29). Diabetic individuals subtyped into groups with/without CHF and/or MI (plasma; n=146). Cancer individuals (pancreatic, breast, prostate, and colorectal at various stages and treatments), (plasma; n=27).

FIG. 4. Population data for mixed cohort of ˜250 individuals. Isoforms representing >5% of RANTES. Healthy individuals subtyped into plasma samples (n=37) and serum samples (n=29). Diabetic individuals subtyped into groups with/without CHF and/or MI (plasma; n=146). Cancer individuals (pancreatic, breast, prostate, and colorectal at various stages and treatments), (plasma; n=27).

FIG. 5. Population data for mixed cohort of -250 individuals. Isoforms representing >5% of RANTES. Healthy individuals subtyped into plasma samples (n=37) and serum samples (n=29). Diabetic individuals subtyped into groups with/without CHF and/or MI (plasma; n=146). Cancer individuals (pancreatic, breast, prostate, and colorectal at various stages and treatments), (plasma; n=27).

### DETAILED DESCRIPTION OF THE INVENTION

The only commercially available assays for RANTES exist as ELISAS. These assays are not multiplexed and tend to have a high degree of cross reactivity and thus error. Conversely, the invention described here is multiplexed, and as outlined in the specific example, can measure 23+ separate variants, unambiguously, and simultaneously (instead of running two separate assays for only 2 variants) in a single analysis. Additionally, this assay allows for the discovery of more RANTES variants related to disease as more differentiated disease states are studied. Lastly, the discovery of entire new catalog of RANTES variants may be used clinically for several diseases including: kidney related complications (e.g. renal failure and renal cancer), autoimmune diseases (e.g. arthritis, diabetes, and glomerulonephritis), and several forms of carcinoma including breast and cervical cancer.

The present invention describes a protein—based analysis that is able to simultaneously detect different variants of RANTES, a protein that is typically considered a single protein as it exists in vivo. Using the assay, the inventors have discovered new variants of RANTES, which are able to distinguish between healthy and diseased individuals with high accuracy. In practice, RANTES (and variants thereof) are targeted from biofluids via affinity isolation—using immobilized affinants in the form of, e.g., antibodies, receptors, proteins, small molecules, aptamers or the like. Once isolated, the proteins are subjected to rigorous, high-performance characterization capable of simultaneously detecting and quantifying multiple variants of the protein—e.g., isoforms of the protein resulting from the different genotypes and phenotypes.

In the given examples, mass spectrometry is used in this role. Data resulting from the assay indicate the genotype (of the gene from which the proteins originated) pertinent to the disease and protein phenotype(s) (generally in the form of posttranslational modification(s)) indicating the presence of the disease. The (absolute or relative) magnitude (quantity) of the protein phenotype is also indicative of the progress of the disease. Thus, in the simultaneous analysis of multiple products of RANTES, at least two generalized metrics that correlate with a disease are obtained—the protein phenotype(s) indicative of the presence of the disease and the abundance of the protein phenotype(s) indicative of the stage of the disease. All data are used for the accurate prediction and diagnosis of disease (e.g., renal disease and failure, osteoporosis, hyper and hypoparathyroidism, parathyroid cancer, and diabetes), as well as in the subsequent monitoring of disease progression and the effect of therapy.

The invention of the multiplexed RANTES assay departs from typical measurements where multiple assays/experiments are required to yield comparable data, hence the multiplexed aspect of this technology. For instance, if a protein exists in five different posttranslationally modified forms—a “healthy” form and four “diseased” forms—the net result is that five highly specific assays are required for complete analysis of the protein and it's corresponding modified forms. Here, a single RANTES diagnostic assay that is able to yield data equal to or surpassing those that result from the combination of several (and often disparate) assays. In practice, RANTES and respective variants are targeted from biofluids via affinity isolation—using immobilized affinants in the form of, e.g., antibodies, receptors, proteins, small molecules, aptamers or the like. Once isolated, RANTES and the respective variants are subjected to rigorous, high performance characterization, including quantification, using mass spectrometry. In summary, data resulting from the assay indicate protein phenotype(s) (in the form of posttranslational modification(s)) which describe the presence of the disease. The measurement also yields the quantity of the protein phenotype, which is indicative of the progress of the disease. Thus, in the simultaneous analysis of multiple RANTES variants, at least two disease-related metrics are obtained—1) the protein phenotype(s) indicative of the presence of the disease and 2) the abundance of the protein phenotype(s) indicative of the stage of the disease. AD data are used for the accurate prediction and diagnosis of disease, as well as in the subsequent monitoring of disease progression and the effect of therapy. All of the discovered variants that can be detected, identified, and quantified using the multiplexed RANTES assay (invention) are outlined in Table 1.

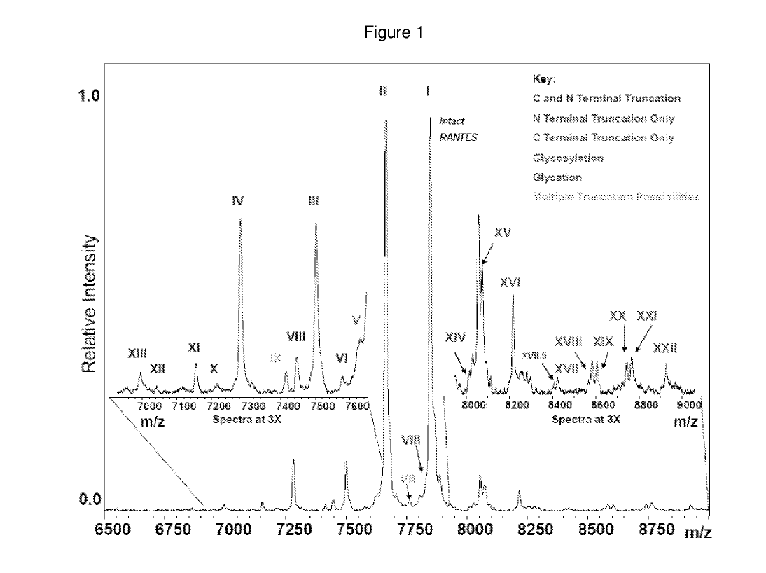

This specific example focuses on the simultaneous analysis of RANTES variants—collectively referred to as RANTES (Swissprot accession# P13501; the sequence is reproduced below as SEQ ID NO:1), in a single multiplex assay. FIG. 1 displays the entire map of RANTES microheterogeneity that is detectable, identifiable, and quantifiable. Table 1 lists the labeled variants and their identity from FIG. 1.

```
SEQ ID NO: 1:
Ser Pro Tyr Ser Ser Asp Thr Thr Pro Cys Cys Phe Ala Tyr Ile Ala
1 5 10 15
Arg Pro Leu Pro Arg Ala His Ile Lys Glu Tyr Phe Tyr Thr Ser Gly
                        20 25 30
Lys Cys Ser Asn Pro Ala Val Val Phe Val Thr Arg Lys Asn Arg Gln
                35 40 45
Val Cys Ala Asn Pro Glu Lys Lys Trp Val Arg Glu Tyr Ile Asn Ser
        50 55 60
Leu Glu Met Ser
65 68
```

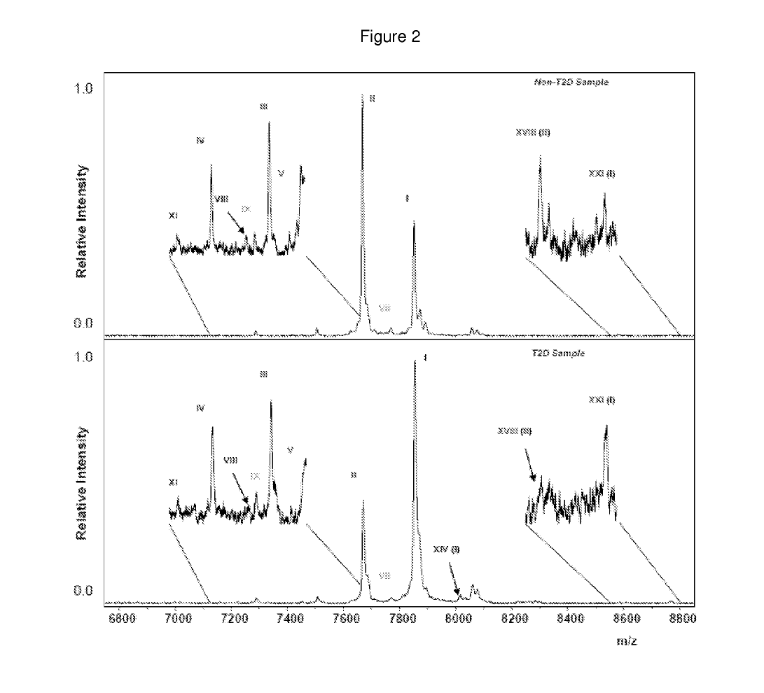

This next specific example focuses on the simultaneous analysis of RANTES variants for the diagnosis of disease. Here we several diseases including T2D, congestive heart failure, myocardial infarct, and cancer were analyzed. A large cohort of 239 individuals were analyzed for RANTES microheterogeneity and substantial percent relative abundance differences were observed between all disease cohorts. Relative percent abundance (RPA) of each unique variant may be obtained (without the use of an internal standard) by integrating all mass spectral peak areas corresponding to variant forms of the target protein, then dividing the peak area of each variant form by the summed areas of all forms and multiplying by one hundred. Using this form of relative quantification, the RPA for RANTES variants was evaluated. For reference, the reproducibility of this assay was tested from running a single individual 96 times (i.e. 96 separate samples from the same donor). In this sample RANTES variants [1-68, i.e., full length of SEQ ID NO:1], [amino acids 3-68 of SEQ ID NO:1], [amino acids 4-68 of SEQ ID NO:1], and [amino acids 4-66 of SEQ ID NO:1] had RPA values and standard deviations of 77.82±0.53, 20.3±0.49, 1.26±0.07, and 0.62±0.05. FIG. 2 shows an example spectrum comparing a T2D individual with a non-diabetic. Table 1 lists the identities of the individual variants found in FIG. 2. Note the correlation between the ratio of [1-68 of SEQ ID NO:1] and [3-68 of SEQ ID NO:1] to the ratio of the glycosylated equivalents. Also note the increase in glycation observed in the T2D sample.

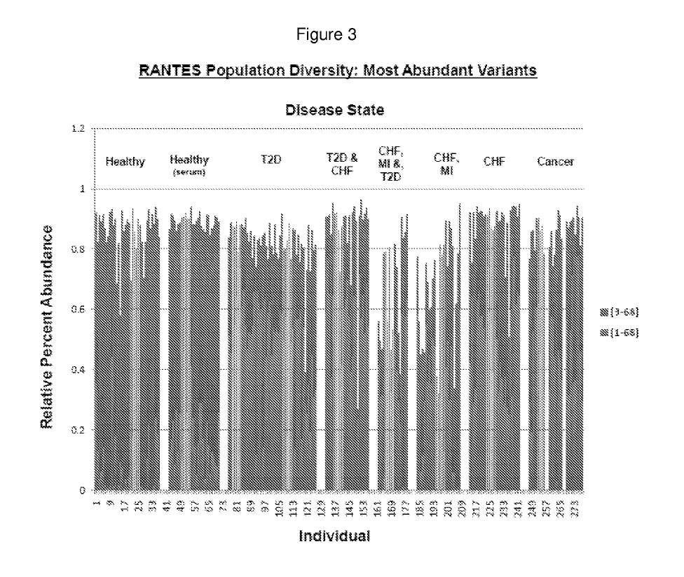

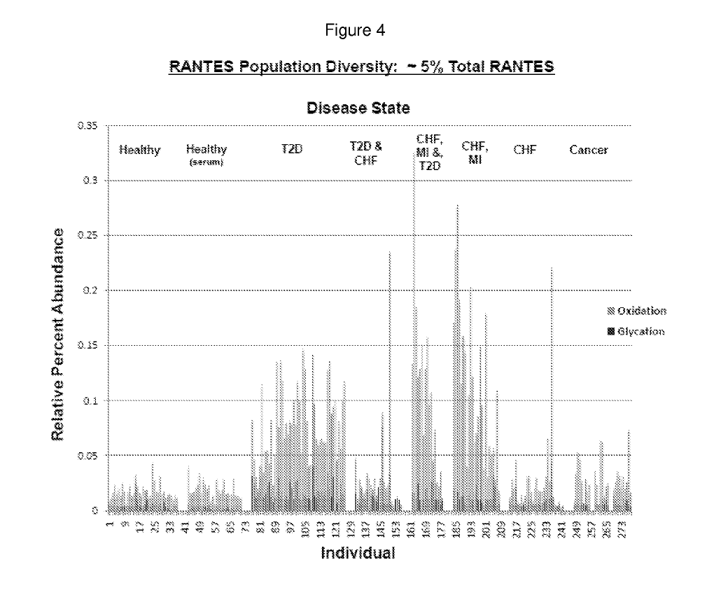

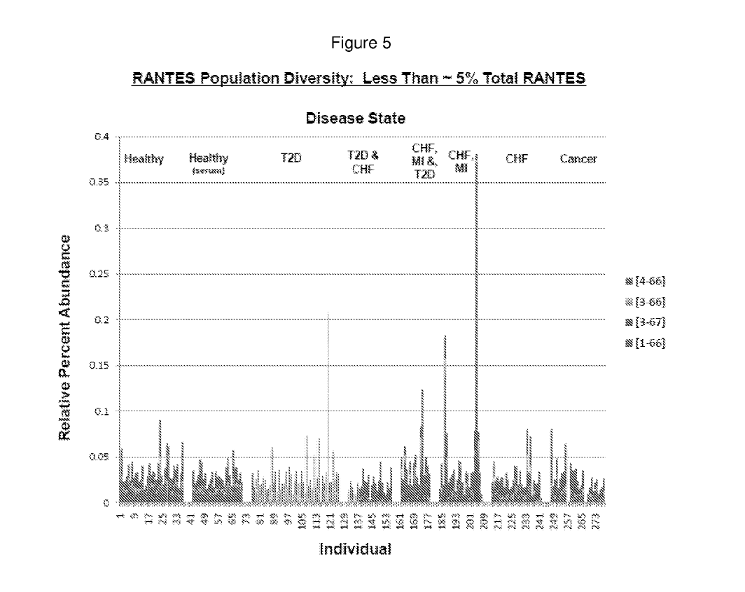

FIGS. 3-5 represent an entire population of 239 individuals in different states of health and the protein diversity found within each subgroup. The relative abundance for three categories of RANTES heterogeneity are displayed in order of figures: isoforms representing the most abundant isoforms (I and II), isoforms around ˜5% of total RANTES, and the lowest level abundance isoforms representing less than ˜5% total RANTES. Substantial percent relative abundance differences were observed between all disease cohorts. The figures compare the relative abundance of [1-68 of SEQ ID NO:1] and [3-68 of SEQ ID NO:1] (FIG. 3), Oxidation and Glycation (FIGS. 4), and [4-66 of SEQ ID NO:1], [3-66 of SEQ ID NO:1], [3-67 of SEQ ID NO:1], and [1-66 of SEQ ID NO:1] (FIG. 5) across all of the disease states. Obvious variation in RANTES profiles begin to emerge in this larger context. For example, in FIG. 3 a large increase in the RPA of [1-68 of SEQ ID NO:1] and a large decrease in RPA of [3-68 of SEQ ID NO:1] is observed in the majority of the diseased individuals relative to the healthy controls. In FIG. 4 glycation increases significantly in the diseased cohorts with the T2D individuals exhibiting the highest relative abundance with a average value and range of 1.84±0.84% and 0.68−4.06% compared to the healthy cohort value of 0.43±0.35% and 0.05−2.55% (note: the glycation calculation comes from adding the glycated [1-68 of SEQ ID NO:1] and [3-68 of SEQ ID NO:1] together). Also observed in FIG. 4 is the markedly higher oxidation of RANTES (and, these values were obtained from adding oxidized [1-68 of SEQ ID NO:1] and [3-68 of SEQ ID NO:1] together) in the diseased individuals with the highest increase observed in those with myocardial infarct with an average value-and range of 9.65±7.16% and 0.27−30.86% compared to the healthy cohort value of 1.42±0.69% and 0.17−3.63%. Finally in FIG. 5, the differences in the relative percent abundances of the lowest level truncated variants is presented with micro differences observed between most disease states including the abnormal higher relative abundance of [1-66 of SEQ ID NO:11 in the CHF and MI individuals with an average value and range of 3.05 35 7.54% and 0.02−36.67% compared to the healthy cohort value of 1.07±0.58% and 0.10−4.26%. Acknowledging heterogeneity in this large context of multiple diseases presents a unique prospect diagnosing several diseases, using independent variant markers, from a single protein analysis. It is only after looking at protein phenotypes (e.g. concentration and posttranslational modifications) in the context of larger sample sets (i.e. populations) when deviations in protein multiplicity, including changes in population frequency and relative abundance, become clear and thus applicable as a candidate biomarker.

Finally, a third application of the multiplexed RANTES MSIA results for the understanding that RANTES variants have modified functionality as a result from enzymatic n-terminal processing. The only two previously established truncated variants, [3-68 of SEQ ID NO:1] and [4-68 of SEQ ID NO:1], appear to be generated by two separate regulatory enzymes: DPP-IV and Cathepsin G, respectively (discovered by others). RANTES, as with most chemokines, contains the receptor binding motif at the n-terminus, thus if truncation proceeds, the consequence modified chemotactic activity. Thus, the information content is twofold within a multiplexed assay: indirectly, the enzymatic activity/expression and directly, the abundance inactive and active protein variants. As realized here, this is in the form of DPP-IV and Cathespsin G activity from the abundance of [amino acids 3-68 of SEQ ID NO:1] and [amino acids 4-68 of SEQ ID NO:1] and each individuals relative ability to induce and/or block signal transduction on target receptors (e.g. full length RANTES versus DPP-IV cleaved RANTES). Thus, this additional application of the RANTES MSIA uses the information content of RANTES variants to show an enzymes relative activity in individuals

Only variants I, II and III have previously been identified. Thus each of the remaining variants identified in Table 1 are novel variants of RANTES that can be used in diagnostic and/or therapeutic applications.

Thus, the present invention provides various previously unrecognized naturally occurring truncated RANTES which can be used for diagnostic purposes and for the identification of different disease states. The truncated RANTES variants may be N-terminally truncated or they may be C-terminally truncated or both N- and C-terminally truncated. These naturally occurring variants of RANTES may also possess one or more chemokine activities of wild-type RANTES. The truncated RANTES of the invention can be in a glycosylated or non-glycosylated form. In some aspects, of the invention, the truncated RANTES may possess chemokine antagonist activity. As used herein, this term “chemokine antagonist” means “which acts as antagonist to the mature full-length naturally-occurring chemokines”. The invention further comprises DNA molecules comprising the DNA sequences coding for the truncated RANTES of the invention, including nucleotide sequences substantially the same. The cDNA sequence of intact RANTES is disclosed in Schall T. J. et at (1988 J Immunol 141(3): 1018-25) and the cDNA of the truncated RANTES can be easily deduced.

The invention also includes expression vectors which comprise the above DNAs, host-cells transformed with such vectors and a process of preparation of such terminally truncated RANTES of the invention, through the culture in appropriate culture media of said transformed cells.

The methods of making the proteins of the invention are standard methods known in the art in which the DNA sequence coding for the proteins of the invention can be inserted and ligated into a suitable plasmid. Once formed, the expression vector is introduced into a suitable host cell, which then expresses the vector(s) to yield the desired protein.

Expression of the terminally truncated recombinant proteins of the invention can be effected in eukaryotic cells (e.g., yeasts, insect or mammalian cells) or prokaryotic cells, using the appropriate expression vectors. Any method known in the art can be employed. In such methods, the DNA molecules coding for the proteins are inserted into appropriately constructed expression vectors by techniques well known in the art. Double stranded cDNA is linked to plasmid vectors by homopolymeric tailing or by restriction linking involving the use of synthetic DNA linkers or blunt-ended ligation techniques: DNA ligases are used to ligate the DNA molecules and undesirable joining is avoided by treatment with alkaline phosphatase.

In order to be capable of expressing the desired protein, an expression vector should also comprise specific nucleotide sequences containing transcriptional and translational regulatory information linked to the DNA coding the desired protein in such a way as to permit gene expression and production of the protein. First in order for the gene to be transcribed, it must be preceded by a promoter recognizable by RNA polymerase, to which the polymerase binds and thus initiates the transcription process. There are a variety of such promoters in use, which work with different efficiencies (strong and weak promoters).

For eukaryotic hosts, different transcriptional and translational regulatory sequences may be employed, depending on the nature of the host. They may be derived form viral sources, such as adenovirus, bovine papilloma virus, Simian virus or the like, where the regulatory signals are associated with a particular gene which has a high level of expression. Examples are the TK promoter of the Herpes virus, the SV40 early promoter, the yeast gal4 gene promoter, etc. Transcriptional initiation regulatory signals may be selected which allow for repression and activation, so that expression of the genes can be modulated.

The DNA molecule comprising the nucleotide sequence coding for the protein of the invention is inserted into vector(s), having the operably linked transcriptional and translational regulatory signals, which is capable of integrating the desired gene sequences into the host cell.

The cells which have been stably transformed by the introduced DNA can be selected by also introducing one or more markers which allow for selection of host cells which contain the expression vector. The marker may also provide for phototrophy to an auxotropic host, biocide resistance, e.g. antibiotics, or heavy metals such as copper, or the like. The selectable marker gene can either be directly linked to the DNA gene sequences to be expressed, or introduced into the same cell by co-transfection. Additional elements may also be needed for optimal synthesis of proteins of the invention.

Factors of importance in selecting a particular plasmid or viral vector include: the ease with which recipient cells, that contain the vector may be recognized and selected from those recipient cells which do not contain the vector; the number of copies of the vector which are desired in a particular host; and whether it is desirable to be able to “shuttle” the vector between host cells of different species.

Once the vector(s) or DNA sequence containing the construct(s) has been prepared for expression the DNA construct(s) may be introduced into an appropriate host cell by any of a variety of suitable means: transformation, transfection, conjugation, protoplast fusion, electroporation, calcium phosphate-precipitation, direct microinjection, etc.

Host cells may be either prokaryotic or eukaryotic. Preferred are eukaryotic hosts, e.g., mammalian cells, such as human, monkey, mouse, and Chinese hamster ovary (CHO) cells, because they provide post-translational modifications to protein molecules, including correct folding or glycosylation at correct sites. Also yeast cells can carry out post-translational peptide modifications including glycosylation. A number of recombinant DNA strategies exist which utilize strong promoter sequences and high copy number of plasmids which can be utilized for production of the desired proteins in yeast. Yeast recognizes leader sequences on cloned mammalian gene products and secretes peptides bearing leader sequences (i.e., pre-peptides).

After the introduction of the vector(s), the host cells are grown in a selective medium, which selects for the growth of vector-containing cells. Expression of the cloned gene sequence(s) results in the production of the desired proteins.

The terminally truncated RANTES of the invention may be prepared by any other well known procedure in the art, in particular, by the well established chemical synthesis procedures, utilizing automated solid-phase peptide synthesizers followed by chromatographic purification.

In addition to recombinant methods for production, the terminally truncated RANTES molecules of the invention may be chemically synthesized using Fmoc (9-fl uorenylmethoxycarbonyl), tboc (t-butoxycarbonyl) or any other comparable chemical synthesis with or without appropriate side-chain protection groups on the different amino acids. In such methods, amino acids with or without appropriate side-chain protection groups are preactivated--e.g., with HBTU/HOBt [2-(1H-Benzotriazole-lyl)-1,1,3,3-tetramethyl-uromium hexafluorophosphate/1-hydroxybenzotriazole)-and coupled to the growing peptide chain. Before the addition of the following residue, the protection group (e.g., Fmoc) is removed from the α-amino group. After synthesis, all protection groups are removed, the intact full-length peptides are purified and chemically or enzymatically folded (including the formation of disulphide bridges between cysteines) into the corresponding chemokines of the invention.

The natural, synthetic or recombinant proteins can be purified using any one of the methods known for this purpose, i.e., any conventional procedure involving extraction, precipitation, chromatography, electrophoresis, or the like. A further purification procedure that may be used in preference for purifying the protein of the invention is affinity chromatography using monoclonal antibodies, or affinity for heparin, which bind the target protein and which are produced and immobilized on a gel matrix contained within a column. Impure preparations containing the proteins are passed through the column. The protein will be bound to the column by the specific antibody while the impurities will pass through. After washing, the protein is eluted from the gel by a change in pH or ionic strength.

The terminally truncated RANTES of the invention are useful in the therapy and/or diagnosis of the diseases, in which an antagonistic activity of the chemokine effects is required. Examples of such diseases include: inflammatory diseases, angiogenesis- and hematopoiesis-related diseases, tumors, infectious diseases, including HIV, auto-immune diseases, atherosclerosis, pulmonary diseases and skin disorders. The preferred use is in the field of HIV-infection.

Therefore, in a further aspect, the present invention provides the use of the protein of the invention in the manufacture of a medicament for the treatment of the above-mentioned diseases. The medicament is preferably presented in the form of a pharmaceutical composition comprising the proteins of the invention together with one or more pharmaceutically acceptable carriers and/or excipients. Such pharmaceutical compositions form yet a further aspect of the present invention.

A further embodiment of the invention is the method of treatment of the above-mentioned diseases comprising administering a pharmacologically active amount of the terminally truncated RANTES of the invention to subjects at risk of developing such diseases or to subjects already showing such pathologies.

| | Observed [M + H]+ | Theoretical [M + H]+ | Identity |
|---|---|---|---|
| Intact | | | |
| I | | 7848.0 | Intact RANTES [1-68] |
| C and N Terminal | | | |
| Truncation | | | |
| VI | 7578.7 | 7576.7 | [3-67] |
| VIII | 7446.9 | 7445.5 | [3-66] |
| IV | 7283.9 | 7282.3 | [4-66] |
| X | 7215.3 | 7213.307 or 7211.407 | [2-63] or [7-68] |
| XI | 7154.0 | 7153.2 | [4-65] |
| XII | 7041.4 | 7040.1 | [4-64] |
| XIII | 6995.4 | 6993.1 or 7002.007 | [7-66] or [3-62] |
| N Terminal | | | |
| Truncation Only | | | |
| II | 7665.3 | 7663.8 | [3-68] |
| III | 7502.1 | 7500.6 | [4-68] |
| C Terminal | | | |
| Truncation Only | | | |
| V | 7632.0 | 7629.7 | [1-66] |
| Multiple Truncation | | | |
| Possibilities | | | |
| IX | 7416.1 | 7413.5 | [2-65], [4-67], or [5-68] |
| VII | 7763.2 | 7760.9 | [1-67] or [2-68] |
| Glycation | | | |
| VII | | | [3-68] + Hex |
| XIV | 8012.6 | | [1-68] + Hex |
| Glycosylation | | | |
| XVI | 8217.1 | 8216.3 | [3-68] + (HexNAc), (Deoxyhex), |
| XVI.5 | 8405.9 | 8400.5 | [1-68] + (HexNAc), (Deoxyhex), |
| XVII | 8423.5 | 8419.5 | [3-68] + (HexNAc), (Deoxyhex), |
| XVIII | 8582.3 | 8581.7 | [3-68] + (Hex), (HexNAc), (Deoxyhex), |
| XIX | 8605.1 | 8603.7 | [1-68] + (HexNAc), (Deoxyhex), |
| XX | 8743.8 | 8743.8 | [3-68] + (Hex), (HexNAc), (Deoxyhex), |
| XXI | 8766.5 | 8765.9 | [1-68] + (Hex), (HexNAc), (Deoxyhex), |
| XXII | 8926.9 | 8927.0 | [1-68] + Deoxyhex, HexNAc, Hex, |
| Oxidation | | | |
| Unlabled | | | |
| Unlabled | | | |
| Sinapinic Matrix Adduct | | | |
| XV | 8072.8 | 8072.2 | [1-68] + M, Sinapic acid |

1-27. (canceled)

28. A method for diagnosing a disorder in which RANTES is involved, comprising simultaneously detecting the presence of different variants of RANTES from a test biological sample in a single assay, said sample taken from a subject having or suspected of having one or more of said disorder, comprising the steps of isolating the RANTES protein from a subject and performing a mass spectrometry analysis on said sample to determine the relative abundance of two or more variants selected from the group consisting of RANTES variant I, RANTES variant II, RANTES variant III, RANTES variant IV, RANTES variant V, RANTES variant VII, RANTES variant VIII, RANTES variant IX, RANTES variant X, RANTES variant XI, RANTES variant XII, RANTES variant XIII, RANTES variant IVX, RANTES variant VX, RANTES variant XVI, RANTES variant XVII, RANTES variant XVIII, RANTES variant XIX, RANTES variant XX, RANTES variant XXI, RANTES variant XXII, RANTES variant XXIII, RANTES variant IVXX, RANTES variant XXV and comparing the abundances of said variants with the relative abundance of the same variants from a control sample taken from one or more healthy individuals.

29. The method of claim 28, wherein increase in the presence of RANTES variant having an amino acid sequence of 1-68 of SEQ ID NO:1 and a decrease in relative abundance of RANTES variant that is the N-terminal truncated of 3-68 of SEQ ID NO:1 in the test biological sample as compared to the control sample from said one or more healthy individuals is indicative that the test biological sample is from an individual that has one or more of said disorder.

30. The method of claim 28, wherein said disorder is selected from the group consisting of T2D, congestive heart failure, myocardial infarct, and cancer.

31. The method of claim 28, wherein in the presence of an increased level of glycation of RANTES variants in the test biological sample as compared to the control sample from said one or more healthy individuals is indicative that the test biological sample is from an individual who has one or more of said disorders.

32. The method of claim 28, wherein in the presence of an increased level of oxidation of RANTES variants in the test biological sample as compared to the control sample is indicative that the test biological sample is from an individual who has one or more of said disorders.

33. A method for diagnosing a disorder in which RANTES is involved, comprising simultaneously detecting the presence of different variants of RANTES from a test biological sample in a single assay, said sample taken from a subject having or suspected of having one or more of said disorder, comprising the steps of isolating the RANTES protein from a subject and performing an analysis on said sample to determine the relative abundance of two or more RANTES protein variants and comparing the abundances of said variants with the relative abundance of the same variants from a control sample taken from one or more healthy individuals.


SEQUENCE LISTING (1 sequence)

SEQ ID NO: 1 - protein, 68 aa, Homo sapiens
SPYSSDTTPCCFAYIARPLPRAHIKEYFYTSGKCSNPAVVFVTRKNRQVCANPEKKWVREYINSLEMS